(19) United States
(12) Patent Application Publication
(10) Pub. No.: US 2014/0258058 A1
(43) Pub. Date: Sep. 11, 2014

(54) COST MANAGEMENT SYSTEM, COST MANAGEMENT APPARATUS, AND COST MANAGEMENT METHOD

(71) Applicant: Yona KASHIDA, Kanagawa (JP)

(72) Inventor: Yona KASHIDA, Kanagawa (JP)

(73) Assignee: RICOH COMPANY, LTD., Tokyo (JP)

(21) Appl. No.: 14/190,204

(22) Filed: Feb. 26, 2014

(30) Foreign Application Priority Data
Mar. 11, 2013 (JP) 2013-048376

(51) Int. Cl. G06Q 20/14

(52) U.S. Cl. CPC G06Q 20/145
USPC 705/34

(57) ABSTRACT

A cost management system includes one or more computers. At least one computer includes an obtainment part configured to obtain usage information of a device; a first storage part configured to store identification information having the usage information associated therewith; a determination part configured to determine a billing destination associated with a cost relating to the usage information based on the identification information having the usage information associated therewith, stored in the first storage part; a generation part configured to generate billing information associated with the cost to the billing destination; and an output part configured to output the billing information.

### BACKGROUND OF THE INVENTION

1. Field of the Invention

The disclosures herein generally relate to a cost management system, a cost management apparatus, and a cost management method.

2. Description of the Related Art

As one working style, telework has been practiced in which business is conducted in a satellite office, a rental office, or the like, that is used in common by multiple different companies. The number of companies adopting telework is expected to increase with the development of communication infrastructure and the like.

In a telework environment, devices such as printers may be shared by employees of mutually different companies. In such a case, cost allocation needs to be conducted appropriately for the use of the device. For example, the cost of the use of the device by an employee of a company A should be allocated to the company A, and the cost of the use of the device by an employee of a company B should be allocated to the company B.

### PATENT DOCUMENTS

[Patent Document 1] Japanese Laid-open Patent Publication No. 2000-214186
[Patent Document 2] Japanese Laid-open Patent Publication No. 2010-086502

### SUMMARY OF THE INVENTION

In view of the above, it is a general object of at least one embodiment of the present invention to make it possible to identify a billing destination of a cost of use of a device.

According to at least one embodiment of the present invention, a cost management system includes one or more computers. At least one computer includes an obtainment part configured to obtain usage information of a device; a first storage part configured to store identification information having the usage information associated therewith; a determination part configured to determine a billing destination associated with a cost relating to the usage information based on the identification information having the usage information associated therewith, stored in the first storage part; a generation part configured to generate billing information associated with the cost to the billing destination; and an output part configured to output the billing information.

According to at least one embodiment of the present invention, it is possible to identify a billing destination for a cost associated with the use of a device.

### BRIEF DESCRIPTION OF DRAWINGS

FIG. 1 is a schematic view illustrating an example of a configuration of a cost management system according to a first embodiment;

FIG. 2 is a schematic view illustrating an example of a functional configuration of a print device according to the first embodiment;

FIG. 3 is a schematic view illustrating an example of a hardware configuration of a cost management apparatus according to the first embodiment;

FIG. 4 is a schematic view illustrating an example of a functional configuration of a user authentication part in a cost management apparatus;

FIG. 5 is a schematic view illustrating an example of a functional configuration of a log collection part in a cost management apparatus;

FIG. 6 is a schematic view illustrating an example of a functional configuration of a cost calculation part in a cost management apparatus;

FIG. 7 is a schematic view illustrating an example of a functional configuration of a billing part in a cost management apparatus;

FIG. 8 is a flowchart illustrating an example of a procedure executed by a print device according to the first embodiment;

FIG. 9 is a schematic view illustrating an example of a usage log;

FIG. 10 is a schematic view illustrating an example of a content log;

FIG. 11 is a flowchart illustrating an example of a procedure executed by a cost calculation part and a billing part according to the first embodiment;

FIG. 12 is a schematic view illustrating an example of a configuration of a charge type storage part;

FIG. 13 is a flowchart illustrating an example of a procedure for selecting a charge type;

FIG. 14 is a schematic view illustrating an example of a configuration of a charge destination information storage part;

FIG. 15 is a flowchart illustrating an example of a procedure for determining a charge destination;

FIG. 16 is a flowchart illustrating an example of a procedure executed by a print device according to a second embodiment; and

FIG. 17 is a schematic view illustrating an example of a configuration of a cost management system according to a third embodiment.

### DETAILED DESCRIPTION OF THE PREFERRED EMBODIMENTS

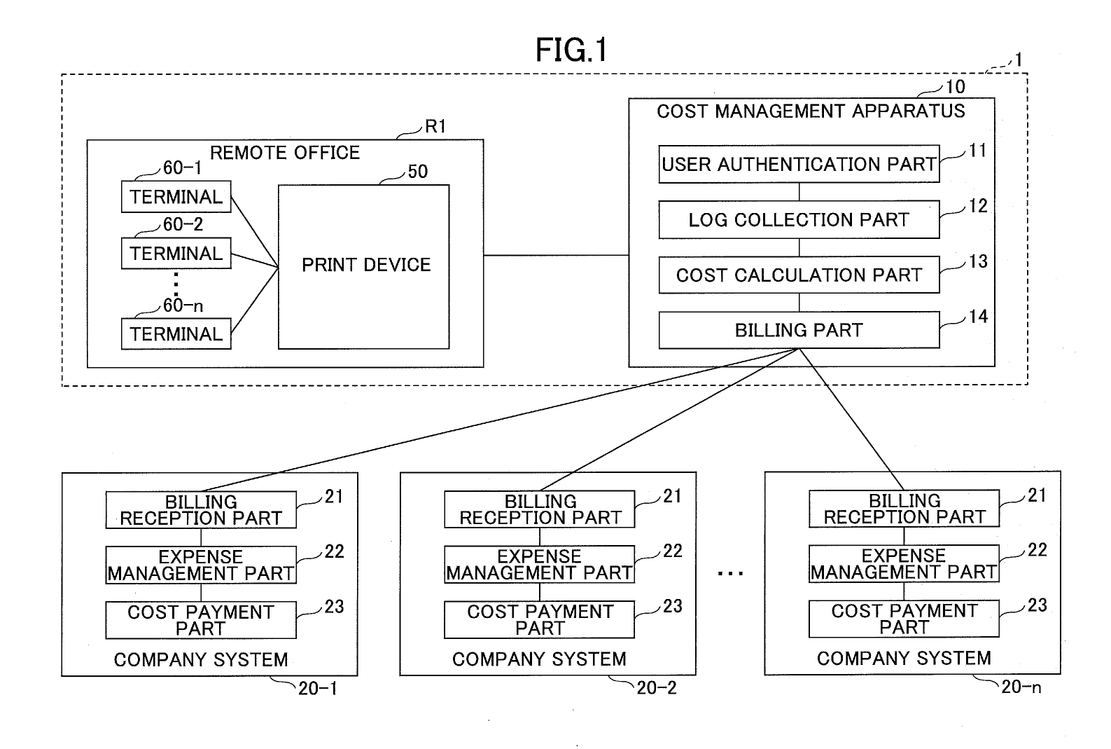

In the following, embodiments of the present invention will be described with reference to the drawings. FIG. 1 is a schematic view illustrating an example of a configuration of a cost management system 1 according to a first embodiment. In the cost management system 1 illustrated in FIG. 1, a remote office R1 is an office that is set up at a remote location from a company, such as a satellite office or a rental office. Employees of multiple companies work at the remote office R1. In the following, a person who works at the remote office R1 is simply called a “worker”.

At the remote office R1, terminals 60-1 to 60-n (called “terminals 60”, hereafter) of workers are connected with a print device 50 via a network such as a LAN (Local Area Network) for communication. The terminal 60 is, for example, a PC (Personal Computer). However, a tablet-type terminal, a smart phone, a cellular phone or the like, may be used as the terminal 60.

The print device 50 is, for example, a printer, a combined machine, a copy machine, or the like. The print device 50 is shared by the workers. Note that the first embodiment will be described with an assumption that the workers use the print device 50 not only for official use (business use), but also for private use.

A cost management apparatus 10 is one or more computers connected with the print device 50 via a network such as a LAN or the Internet. Namely, multiple computers may constitute the cost management apparatus 10. The cost management apparatus 10 is operated by, for example, an administrator of the remote office. In FIG. 1, the cost management apparatus 10 includes a user authentication part 11, a log collection part 12, a cost calculation part 13, a billing part 14, and the like. The user authentication part 11 authenticates a user of the print device 50. The log collection part 12 collects usage information of the print device 50 from the print device 50. The usage information is information including the amount of usage, usage content, and the like of the print device 50. In the present embodiment, log data of each print job is taken as an example of the usage information. Timing of a collection of log data may not necessarily be the timing of an execution of a print job. For example, log data may be collected or received periodically, for example, once in a day, for all jobs for the day.

The cost calculation part 13 calculates a cost (charge) of an executed print job based on the log data. The billing part 14 determines a billing destination of the cost calculated by the cost calculation part 13, and transmits information that indicates a billing amount of the cost and the like (called “billing information”, hereafter) to the billing destination. If the billing destination is a company at which one of the workers works, the billing information is transmitted to a company system 20 of the corresponding company among company systems 20-1 to 20-n (called the “company system 20”, hereafter).

The company system 20 is a computer system at each of the companies, and includes, for example, a billing reception part 21, an expense management part 22, a cost payment part 23, and the like. The billing reception part 21 receives billing information. The expense management part 22 manages expenses in a company. The cost payment part 23 executes a payment procedure of the cost corresponding to a charge amount indicated by billing information. Although each of the company systems 20 has the same configuration in FIG. 1 for convenience's sake, the computer system 20 may be discretionarily configured by each of the companies.

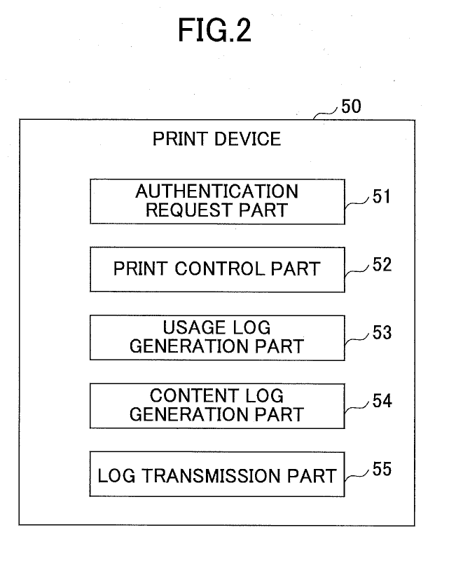

FIG. 2 is a schematic view illustrating an example of a functional configuration of a print device 50 according to the first embodiment. In FIG. 2, the print device 50 includes an authentication request part 51, a print control part 52, a usage log generation part 53, a content log generation part 54, a log transmission part 55, and the like. These parts are implemented by procedures that one or more programs installed in the portable terminal 10 have the CPU 101 execute.

The authentication request part 51 transmits an authentication request of account information input by a user to the user authentication part 11. The authentication request part 51 permits use of the print device 50 if a response from the user authentication part 11 indicates that the authentication succeeds. Note that the account information is information for identifying a user. For example, a user name and a password, a card ID, a personal identification number, or the like may be used as the account information. Also, the account information may be included, for example, in print data transmitted from the terminal 60, or may be input via an operation panel of the print device 50. To include the account information in print data, a user may input the account information via a print setting screen or the like when giving a print command at a terminal 60. As an example of inputting the account information via the operation panel of the print device 50, there is a case where the print device 50 preserves print data until the authentication succeeds, and upon the success of the authentication, executes a print job for the print data.

The print control part 52 has the print device 50 output (print) image information included in the received print data. The usage log generation part 53 generates a usage log based on print setting information included in the print data. The usage log is generated based on a group of setting values of print setting items in the print setting information that relate to (affect) the print cost. The usage log also includes identification information (called a “user name”, hereafter) of a worker who uses the print device 50. The user name is extracted from the account information. The content log generation part 54 generates a content log. The content log is data that includes content output by the print device 50 (for example, image information included in the print data). Note that the content log generation part 54 generates a content log only for official purpose printing. The distinction between official and private purpose printing (purpose of use of the print device 50) may be specified in the print data, or may be input via the operation panel of the print device 50. In the former case, The distinction between official and private purpose printing may be selected on a print setting screen or the like.

The log transmission part 55 transmits the usage log and content log to the log collection part 12. However, for the print data (print job) not having the content log generated, the content log is not transferred.

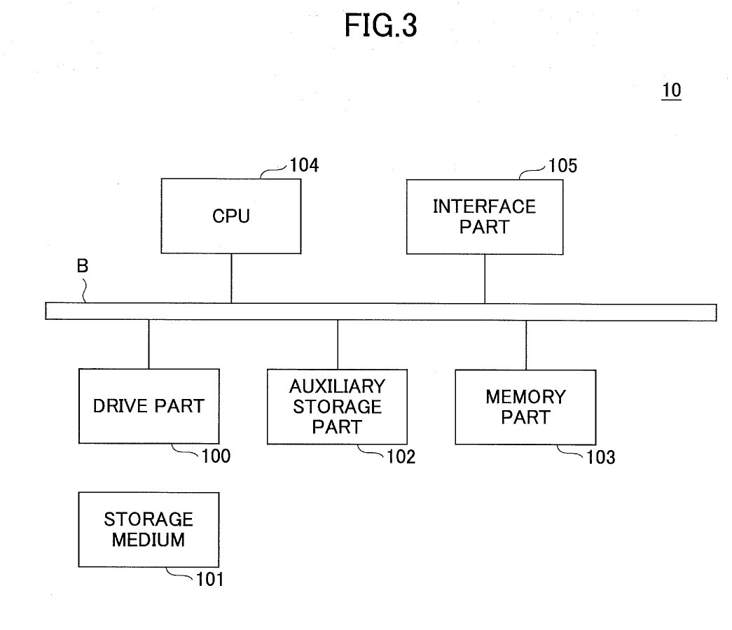

FIG. 3 is a schematic view illustrating an example of a hardware configuration of the cost management apparatus 10 according to the first embodiment. The cost management apparatus 10 in FIG. 3 includes a drive part 100, an auxiliary storage part 102, a memory part 103, a CPU 104, an interface part 105, and the like that are mutually connected via a bus B.

A program that implements processing on the cost management apparatus 10 is provided with a recording medium 101. When the recording medium 101 storing the program is set in the drive device 100, the program is installed into the auxiliary storage device 102 from the recording medium 101 via the drive device 100. However, installation of the program is not necessarily executed from the recording medium 101, but may be downloaded from another computer via the network. The auxiliary storage device 102 stores the installed program, and stores required files, data, and the like as well.

The memory device 103 reads the program from the auxiliary storage device 102 to store the program into it when receiving a start command for the program. The CPU 104 implements functions relating to the cost management apparatus 10 by executing the program stored in the memory device 103. The interface device 105 is used as an interface for connecting with the network.

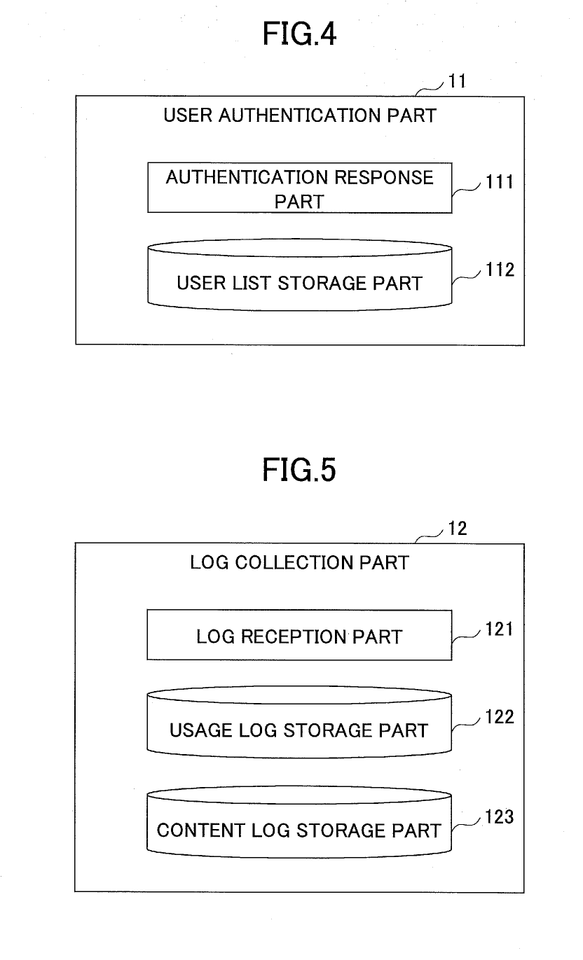

FIG. 4 is a schematic view illustrating an example of a functional configuration of the user authentication part 11 in the cost management apparatus 10. In FIG. 4, the user authentication part 11 includes an authentication response part 111, a user list storage part 112, and the like. The authentication response part 111 authenticates account information in response to an authentication request. The user list storage part 112 stores a list of account information.

FIG. 5 is a schematic view illustrating an example of a functional configuration of the log collection part 12 in the cost management apparatus 10. In FIG. 5, the log collection part 12 includes a log reception part 121, a usage log storage part 122, a content log storage part 123, and the like.

The log reception part 121 receives a usage log and a content log transmitted from the print device 50. The usage log storage part 122 stores the received usage log. The content log storage part 123 stores the received content log.

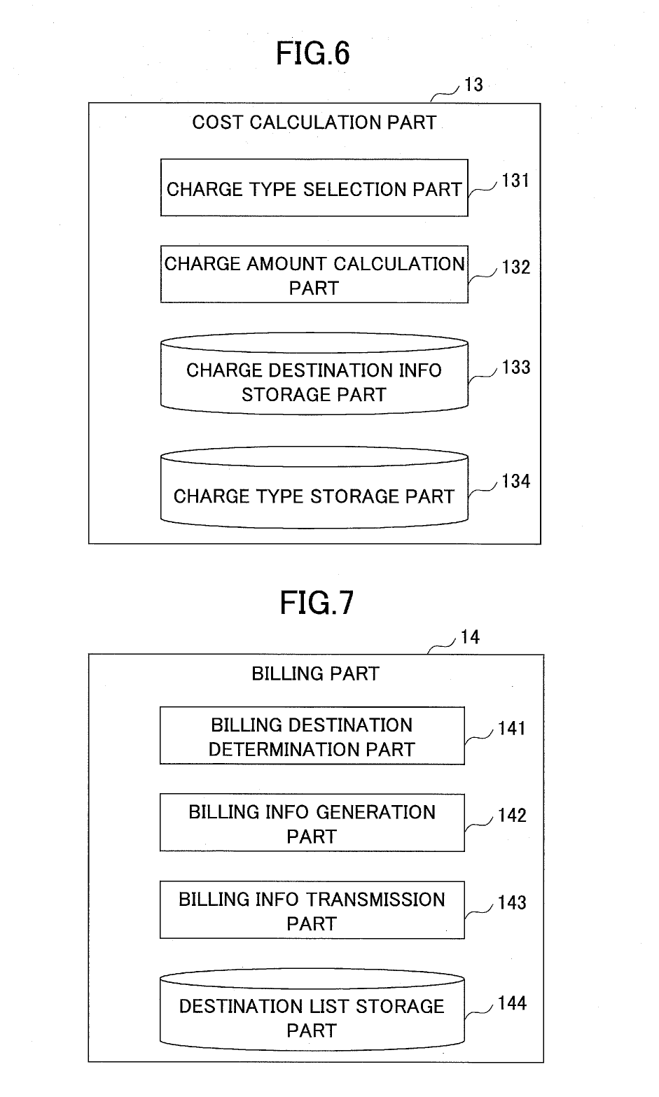

FIG. 6 is a schematic view illustrating an example of a functional configuration of the cost calculation part 13 in the cost management apparatus 10. In FIG. 6, the cost calculation part 13 includes a charge type selection part 131, a charge amount calculation part 132, a charge destination information storage part 133, a charge type storage part 134, and the like.

The charge type selection part 131 selects a charge type to be applied to calculation of a charge amount for each piece of log data among multiple charge types stored in the charge type storage part 134. The charge type is a notion for classifying part charges for use of the print device 50. Print jobs of the same material may have different charge amounts if different charge types are applied to the respective jobs. The charge amount calculation part 132 calculates a charge amount based on the selected charge type. The charge destination information storage part 133 stores information for each user that indicates the billing destination (charge destination) of charge amounts.

FIG. 7 is a schematic view illustrating an example of a functional configuration of the billing part 14 in the cost management apparatus 10. In FIG. 7, the billing part 14 includes a billing destination determination part 141, a billing information generation part 142, a billing information transmission part 143, a destination list storage part 144, and the like.

The billing destination determination part 141 determines the billing destination associated with a cost. The billing information generation part 142 generates billing information. The billing information transmission part 143 transmits the billing information to the billing destination associated with the cost. The destination list storage part 144 stores address information (for example, e-mail addresses) of each worker or company to which billing information of a cost charged to the worker or company is to be transmitted.

Note that, in FIGS. 4-7, the log reception part 121, the charge type selection part 131, the charge amount calculation part 132, the billing destination determination part 141, the billing information generation part 142, the billing information transmission part 143, and the like are implemented by procedures that the program installed in the cost management apparatus 10 has the CPU 104 execute.

Also, the user list storage part 112, the usage log storage part 122, the content log storage part 123, the charge destination information storage part 133, the charge type storage part 134, the destination list storage part 144, and the like may be implemented by the auxiliary storage part 102 or a storage device (not shown) connected with the cost management apparatus 10 via the network.

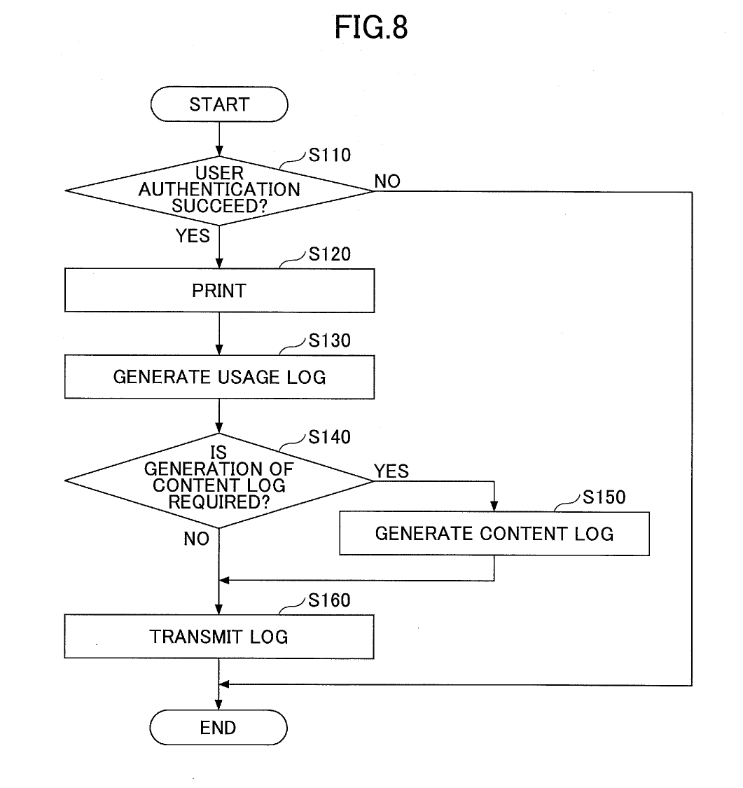

In the following, procedures executed by the cost management system 1 will be described. FIG. 8 is a flowchart illustrating an example of a procedure executed by the print device 50 according to the first embodiment. The procedure in FIG. 8 is executed, for example, in response to a print request input to the print device 50. A print request may be input with a reception of print data transmitted from a terminal 60, or with inputting account information via the operation panel.

At Step S110, the authentication request part 51 transmits an authentication request to the user authentication part 11 for account information included in print data or account information input via the operation panel. The authentication response part 111 of the user authentication part 11 determines whether to authenticate based on whether the account information is stored in the user list storage part 112. The authentication response part 111 replies with a response that includes information about success or failure of the authentication to the authentication request part 51.

If the response indicates failure of the authentication (Step S110 NO), the procedure in FIG. 8 ends. If the response indicates success of the authentication (Step S110 YES), the print control part 52 has the print device 50 execute a print job based on the received print data (Step S120). Next, the usage log generation part 53 generates a usage log of the executed print job based on the print setting information included in the print data (Step S130).

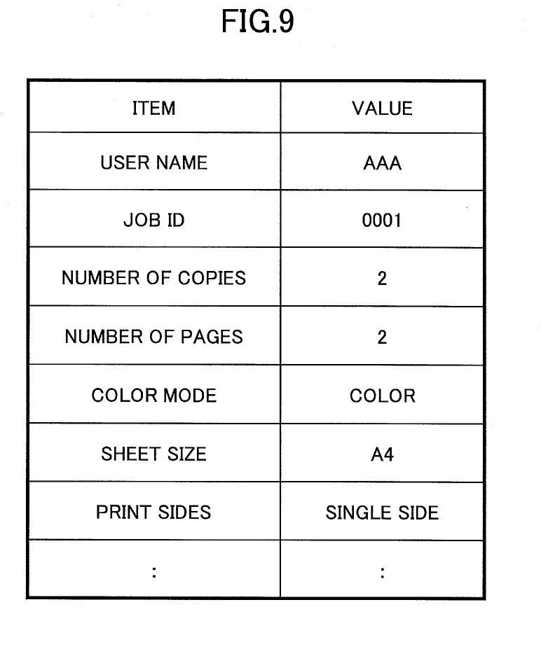

FIG. 9 is a schematic view illustrating an example of a usage log. In FIG. 9, the usage log includes, as setting items, a user name, a job ID, the number of copies, the number of pages per copy, and values of these setting items of print setting information. Note that other information such as print date and time may be included in the usage log.

Next, the content log generation part 54 determines whether to generate a content log based on information that indicates distinction between official and private of the purpose of printing, which is included in the received print data, or input via the operation panel of the print device 50 (Step S140). If the information indicates an official purpose, the content log generation part 54 determines that generation of the content log is required. If the information indicates a private purpose, the content log generation part 54 determines that generation of the content log is not required.

If generation of the content log is required (Step S140 YES), the content log generation part 54 generates the content log about the print job based on the print data (Step S150).

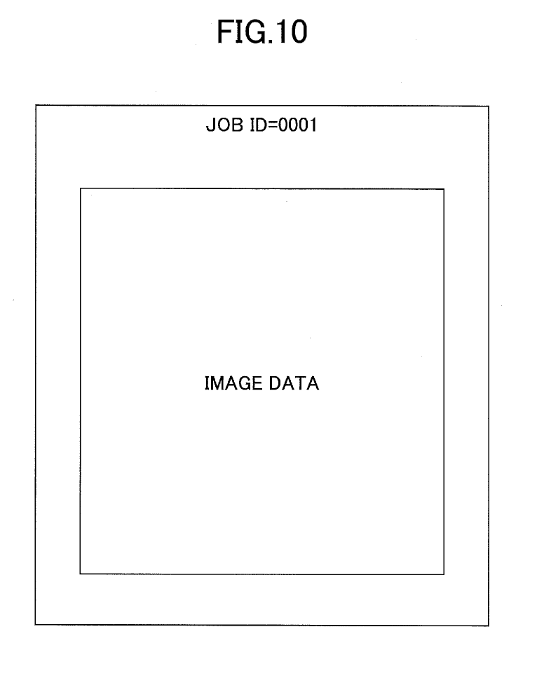

FIG. 10 is a schematic view illustrating an example of a content log. As illustrated in FIG. 10, the content log includes a job ID and image data of a printed image. The usage log and the content log for a specific print job include common identification information, respectively. The usage log can be associated with the content log by the identification information. In the present embodiment, the job ID of a print job is used as the identification information. However, identification information other than the job ID may be used as the identification information.

Next, the log transmission part 55 transmits the generated log data to the log collection part 12 (Step S160). The log data includes the usage log at least. If the content log is generated, the log data also includes the content log. Note that address information of a transmission destination of the log data is stored beforehand, for example, in the auxiliary storage part of the print device 50. Examples of the address information include an IP address and a port number, a URL (Uniform Resource Locator), and the like. Note that the usage log and the content log may not necessarily be transmitted at the same time.

The log reception part 121 of the log collection part 12 stores the received log data into the usage log storage part 122 or the content log storage part 123. The usage log is stored into the usage log storage part 122. The content log is stored into the content log storage part 123.

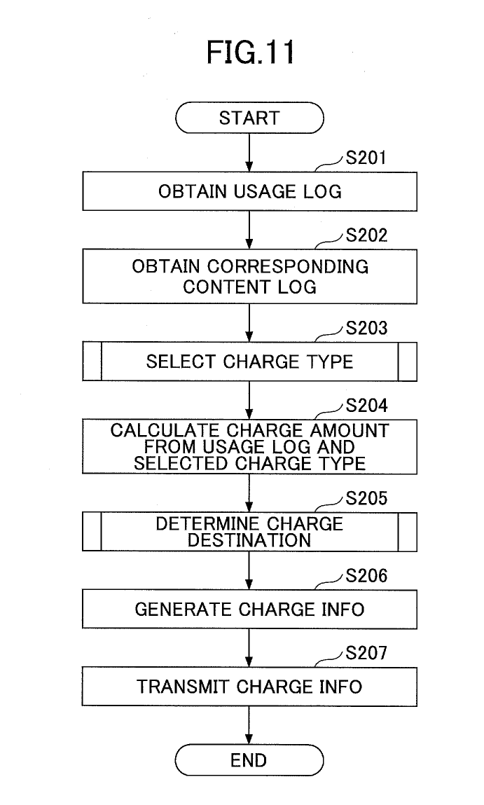

Following the procedure in FIG. 8 or at a predetermined timing, the cost calculation part 13 executes a procedure illustrated in FIG. 11. FIG. 11 is a flowchart illustrating an example of the procedure executed by the cost calculation part 13 and the billing part 14 according to the first embodiment.

At Step S201, the charge type selection part 131 obtains an unprocessed usage log from the usage log storage part 122. “Unprocessed” means that the procedure in FIG. 11 has not been applied yet. Next, the charge type selection part 131 obtains a content log that corresponds to the obtained usage log from the content log storage part 123 (Step S202). “A content log that corresponds to the obtained usage log” is, for example, a content log having the same job ID. Note that a content log is not obtained if there is no corresponding content log.

Next, the charge type selection part 131 selects a charge type that is to be applied to the printing related to the obtained usage log (called the “target usage log”, hereafter) (Step S203). Selection of the charge type selects a charge type among multiple charge types stored in the charge type storage part 134.

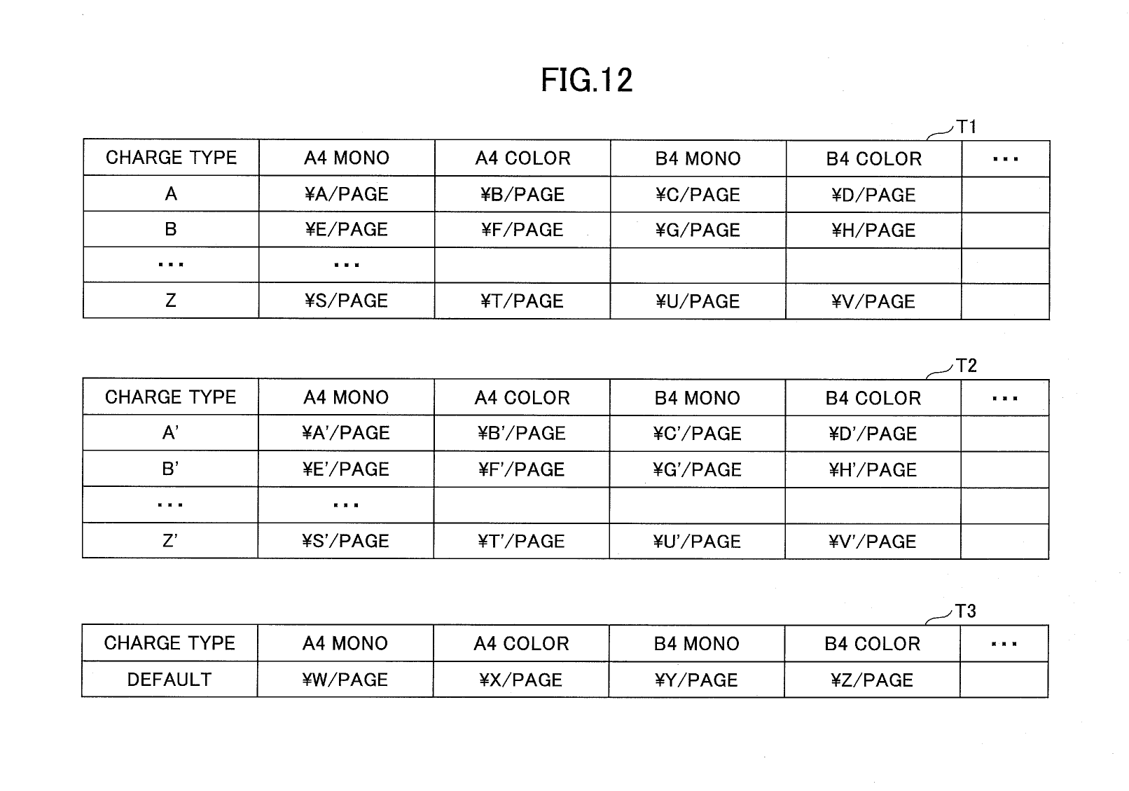

FIG. 12 is a schematic view illustrating an example of a configuration of the charge type storage part. In FIG. 12, the example has three charge tables, namely, an official charge table T1, a private charge table T2, and a default charge table T3 in which charge types are registered.

The official charge table T1 is a charge table in which charge types of printing for official purposes are registered. The private charge table T2 is a charge table in which charge types of printing for private purposes are registered. The default charge table T3 is a charge table in which a default charge type is registered. The meaning of “default” will be clarified below.

Each of the charge tables is set with a part charge per page defined for each print condition or print form (called “part charge information”, hereafter) for each of the charge types. Therefore, print jobs of exactly the same material may have different part charges if the charge types are different. By making it possible to set the multiple charge types, it is possible to provide a service, for example, to set a discount rate for a major account.

Next, the charge amount calculation part 132 calculates a charge amount for the printing related to the target usage log based on the target usage log and the part charge information of the selected charge type (Step S204). For example, if the target usage log is as illustrated in FIG. 9, the charge amount is calculated by multiplying the part charge for “A4 color” by the number of copies and by the number of pages. Note that the charge amount for duplex printing may be twice as much.

Next, the billing destination determination part 141 determines a charge destination (billing destination of the cost relating to the charge amount) (Step S205). Details of Step S205 will be described later. Next, the billing information generation part 142 of the billing part 14 generates billing information that includes the calculated charge amount (Step S206). Next, the billing information transmission part 143 transmits the billing information to the charge destination (Step S207). Address information to which the billing information corresponding to the charge destination is to be transmitted is stored in the destination list storage part 144.

Note that transmission of the billing information at Step S207 may not be executed for each usage log. For example, an accumulated result of billing information for a charge destination may be transmitted to the charge destination after the steps up to Step S206 have been completed for all relevant usage logs.

Also, the output form of the billing information is not limited to through transmission. It may be output through printing by a printer or the like or displaying by a display part. In this case, an indication of the billing information to the charge destination may be done with mailing, FAX, or the like.

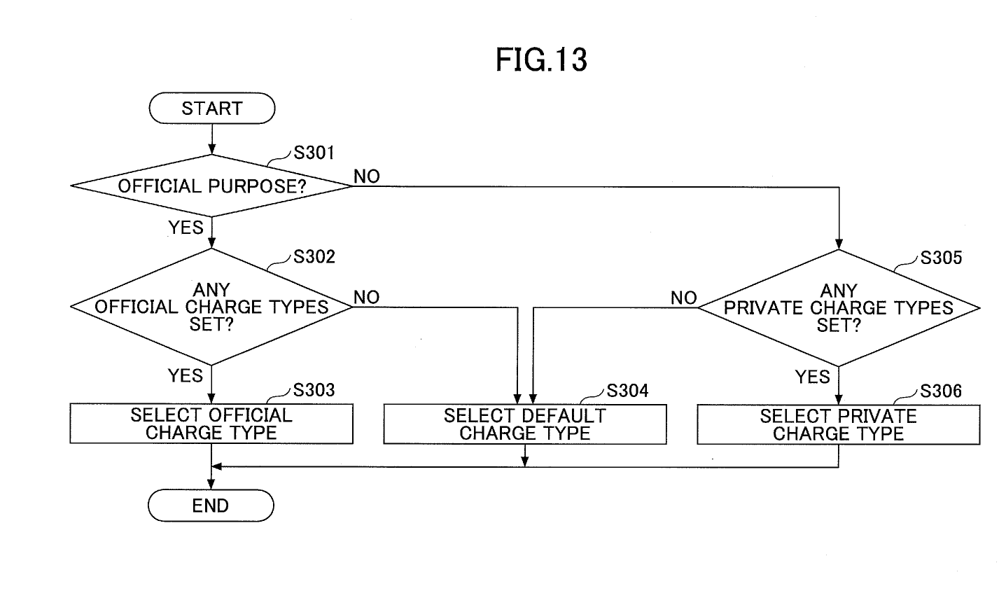

Next, Step S203 will be described in detail. FIG. 13 is a flowchart illustrating an example of a procedure for selecting a charge type.

At Step S301, the charge type selection part 131 determines whether the printing relating to the target usage log is for an official purpose, based on whether there is a content log corresponding to the target usage log. If the printing relating to the target usage log is for an official purpose, namely, if the corresponding content log exists (Step S301 YES), the charge type selection part 131 determines whether a charge type for official use is set for a user name included in the target usage log (called the “target user name”, hereafter) in the charge destination information storage part 133 (Step S302).

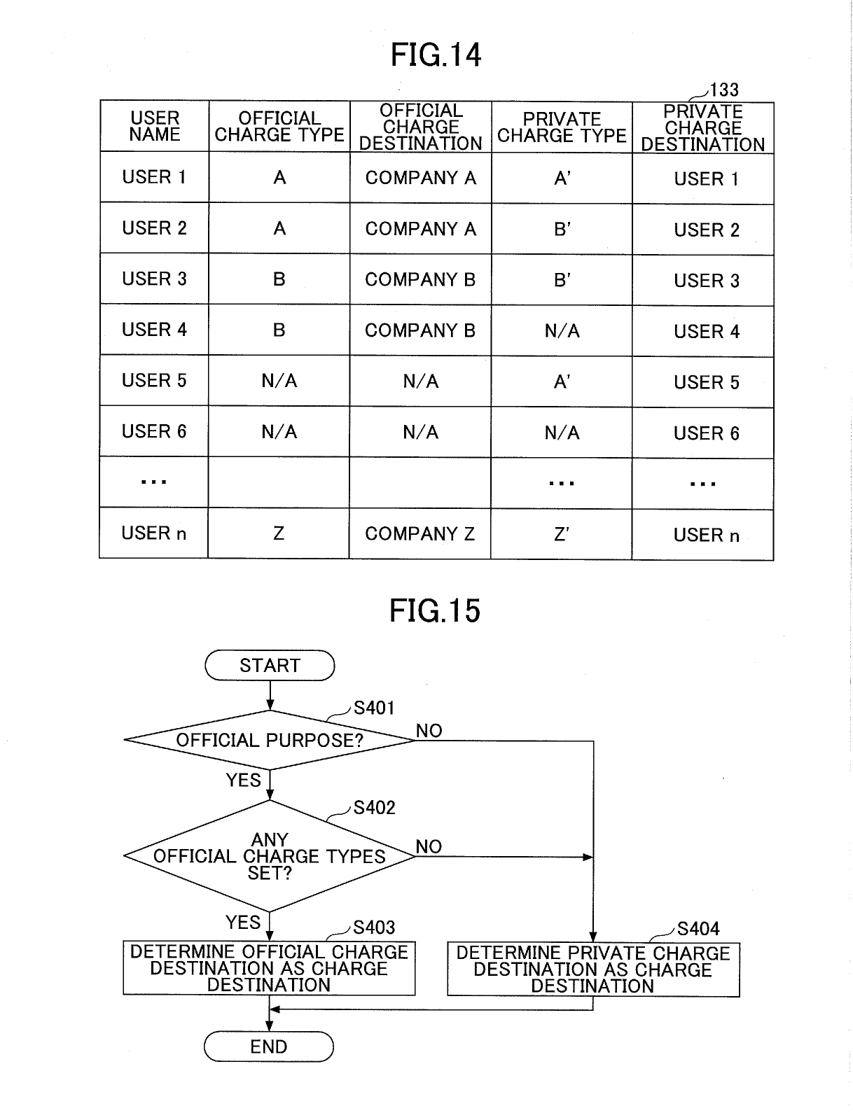

FIG. 14 is a schematic view illustrating an example of a configuration of the charge destination information storage part 133. In FIG. 14, the charge destination information storage part 133 stores a user name, an official use charge type, an official use charge destination, a private use charge type, a private use charge destination, and the like for each worker. The official use charge type corresponds to a charge type included in the official charge table T1. The official use charge destination is identification information of a charge destination for official purpose printing. The private use charge type corresponds to a charge type included in the private charge table T2. The private use charge destination is identification information of a charge destination for private purpose printing. Note that, if the private use charge destination designates no other person than the worker, the item of the private use charge destination may not be set.

At Step S302, the charge type selection part 131 determines whether the official use charge type is set with a value in the charge destination information storage part 133 for the target user name. If the official use charge type is set with a value for the target user name, the charge type selection part 131 selects the official use charge type in the official charge table T1 as the charge type to be applied (Step S303). If the official use charge type is not set with a value for the target user name, the charge type selection part 131 selects the default charge type in the default charge table T3 as the charge type to be applied (Step S304).

On the other hand, if the printing relating to the target usage log is private purpose printing, namely, if there is no corresponding content log (Step S301 NO), the charge type selection part 131 determines whether the private use charge type is set with a value in the charge destination information storage part 133 for the target user name (Step S305). If the private use charge type is set with a value for the target user name, the charge type selection part 131 selects the private use charge type in the private charge table T1 as the charge type to be applied (Step S305). If the private use charge type is not set with a value for the target user name, the charge type selection part 131 selects the default charge type in the default charge table T3 as the charge type to be applied (Step S304).

Next, Step S205 in FIG. 11 will be described in detail. FIG. 15 is a flowchart illustrating an example of a procedure for determining a charge destination.

At Step S401, the billing destination determination part 141 determines whether the printing relating to the target usage log is for an official purpose, based on whether there is a content log corresponding to the target usage log. Namely, whether it is for an official purpose is determined based on the configuration of log data (usage information). If the printing relating to the target usage log is official purpose printing, namely, if there is a corresponding content log (Step S401 YES), the billing destination determination part 141 determines whether an official use charge destination is set in the charge destination information storage part 133 for the target user name included in the target usage log (Step S402). If a corresponding official use charge destination is set (Step S402 YES), the billing destination determination part 141 determines the official use charge destination as the charge destination (Step S403).

If a corresponding official use charge destination is not set (Step S402 NO), the billing destination determination part 141 determines the private use charge destination set in the charge destination information storage part 133 as the charge destination for the target user name (Step S404). Also, if the printing relating to the target usage log is private purpose printing, namely, if there is no corresponding content log (Step S401 NO), the billing destination determination part 141 determines the private use charge destination set in the charge destination information storage part 133 for the target user name as the charge destination (Step S404).

As described above, it is possible to distinguish multiple companies as billing destinations of charge amounts for usage of the print device 50 shared by employees of the multiple companies according to the first embodiment. Also, it is possible not only to identify each of the multiple companies, but also to specify either of the company or an employee at the company as the charge destination depending on the distinction of official use or private use.

Note that, by transferring a content log for official purpose printing with which the content that has been output by the print device 50 can be confirmed, a worker may feel psychological pressure if the worker attempts to print a private-purpose material as an official-purpose material. Namely, the companies can prevent their workers from making fraudulent usage as an environment is provided where output content can be confirmed anytime with the content log.

Next, a second embodiment will be described. In the second embodiment, points that differ from those in the first embodiment will be described. Therefore, points that are not specifically mentioned may be the same as in the first embodiment.

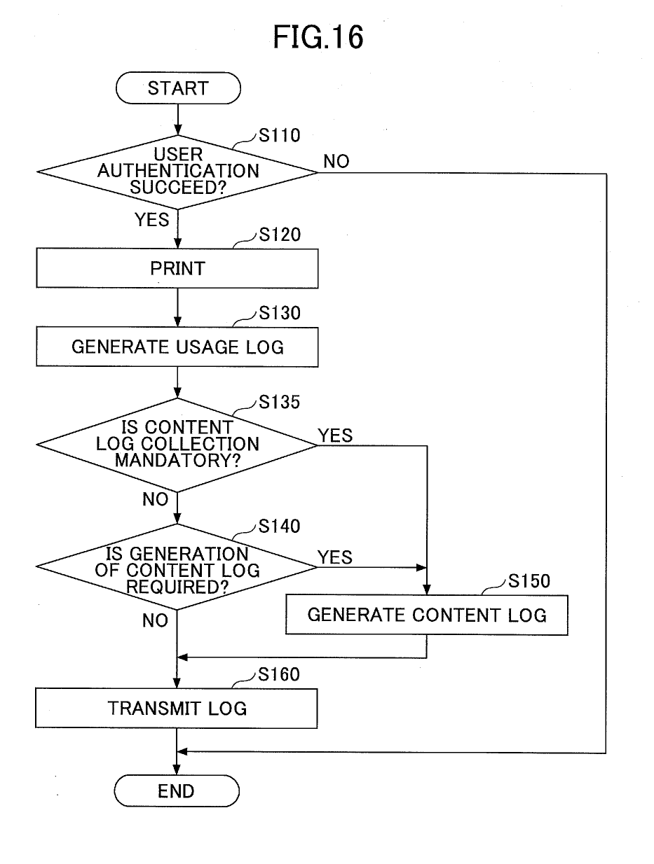

In the second embodiment, an example will be described in which use of the print device 50 for private purposes can be suppressed. Specifically, the print device 50 can be set to indicate whether transmission of a content log is mandatory. In this case, the print device 50 executes a procedure illustrated in FIG. 16 instead of the procedure in FIG. 8.

FIG. 16 is a flowchart illustrating an example of the procedure executed by the print device 50 according to the second embodiment. In FIG. 16, the same steps as in FIG. 8 are assigned the same step numbers, and their description is omitted.

Following Step S130, the content log generation part 54 determines whether generation of a content log is mandatory (Step S135). The determination may be done based on information that indicates whether generation of a content log is mandatory, which has been stored in the storage device of the print device 50 or the like via, for example, an operation screen that is set accessible only for a specified person. If generation of a content log is mandatory (Step S135 YES), the content log generation part 54 generates a content log regardless of distinction of the purpose of printing, official or private, that has been specified by a user (Step S150). Therefore, in this case, the content log is transmitted.

As described above, according to the second embodiment, it is possible to suppress private-purpose usage of the print device 50 by setting generation of a content log as mandatory.

Next, a third embodiment will be described. In the third embodiment, points that differ from those in the first or second embodiment will be described. Therefore, points that are not specifically mentioned may be the same as in the first or second embodiment.

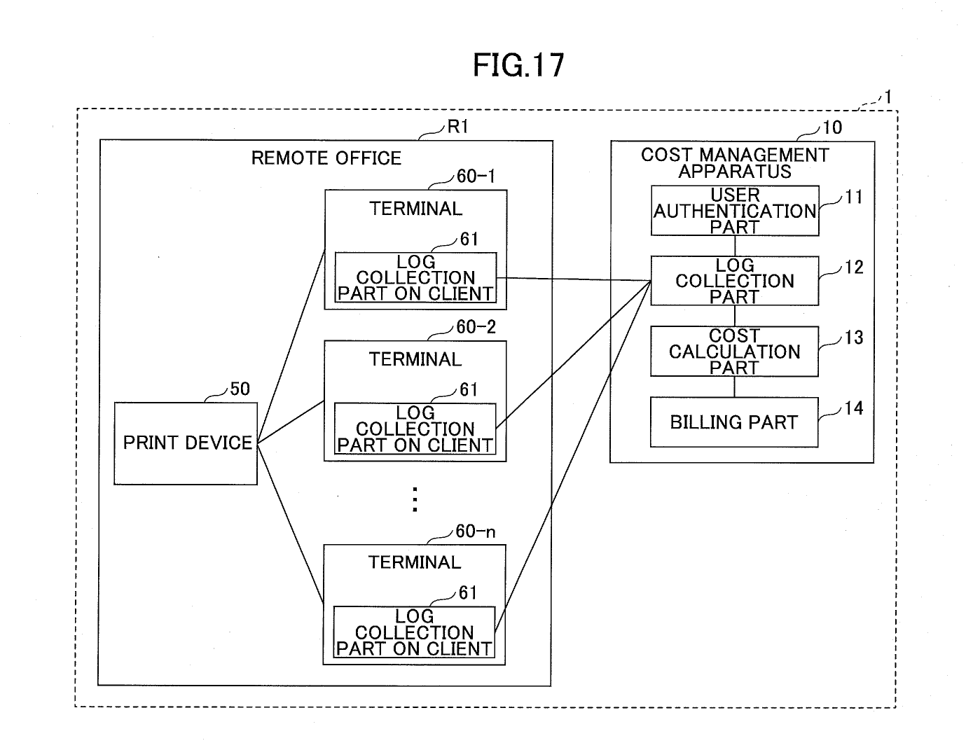

FIG. 17 is a schematic view illustrating an example of a configuration of a cost management system 2 according to the third embodiment. In FIG. 17, the same elements as in FIG. 1 are assigned the same numerical codes, and their description is omitted. Note that, in FIG. 17, company systems 20 are omitted for convenience's sake.

In the cost management system 2 illustrated in FIG. 17, each terminal 60 includes a log collection part on client 61. The log collection part on client 61 implements substantially the same functions as those implemented by the authentication request part 51, the usage log generation part 53, the content log generation part 54, the log transmission part 55 and the like in FIG. 2. Therefore, in the third embodiment, each of the terminals 60 can execute the procedure described in FIG. 8. Note that content of Step S120 may be replaced with transmission of print data to the print device 50. Also, the terminal 60 may make a query to the print device 50 whether printing of the print data has been normally executed, and if the printing has been normally executed, then executes Steps S130 and after.

In this way, log data may be transmitted from the terminal 60. Also, whether log data is transmitted by the terminal 60 or by the print device 50 may be specified at the terminal 60.

Note that the above embodiments may be applied to devices other than the print device 50 or an image forming apparatus. For example, the above embodiments may be applied to a projector and a TV conference system. When applied to a projector, the usage log may include, for example, use time and power consumption. The content log may include output (projected) image data, or may include a file or a file name for storing the projected image data. Also, if the amount of such image data is large, thumbnail images of the image data may be included in the content log. When applied to a TV conference system, the usage log may include, for example, use time and power consumption of the TV conference system. Also, the content log may include address information of a counterpart of communication, output (displayed) images of the counterpart of communication taken at certain intervals with the TV conference system.

Note that, in the above embodiments, the log reception part 121 is an example of an obtainment part. The billing destination determination part 141 is an example of a determination part. The billing information generation part 142 is an example of a generation part. The billing information transmission part 143 is an example of an output part. The charge destination information storage part 133 is an example of a first storage part. The charge type storage part 134 is an example of a second storage part.

Further, the present invention is not limited to the specific embodiments described herein, and variations and modifications may be made without departing from the spirit and scope of the present invention.

The present application is based on and claims the benefit of priority of Japanese Priority Patent Application No. 2013-048376, filed on Mar. 11, 2013, the entire contents of which are hereby incorporated herein by reference.

What is claimed is:

1. A cost management system including one or more computers, at least one computer comprising:
an obtainment part configured to obtain usage information of a device;
a first storage part configured to store identification information having the usage information associated therewith;
a determination part configured to determine a billing destination associated with a cost relating to the usage information, based on the identification information having the usage information associated therewith, stored in the first storage part;
a generation part configured to generate billing information of the cost to the billing destination; and
an output part configured to output the billing information.

2. The cost management system as claimed in claim 1, wherein the determination part determines a usage purpose of the device based on a configuration of the usage information, and then determines the billing destination based on the usage purpose.

3. The cost management system as claimed in claim 1,
wherein at least the one computer further comprises a second storage part configured to store part charge information for use of the device, the part charge information being associated with the identification information,
wherein the generation part generates the billing information based on the part charge information stored in the second storage part.

4. The cost management system as claimed in claim 3, wherein the part charge information stored in the second storage part is classified based on the usage purpose of the device.

5. The cost management system as claimed in claim 2, wherein the determination part determines the usage purpose of the device as an official use if the usage information includes content output by the device, or determines the usage purpose of the device as a private use if the usage information does not include the content output by the device.

6. A cost management apparatus comprising:
an obtainment part configured to obtain usage information of a device;
a first storage part configured to store identification information having the usage information associated therewith;
a determination part configured to determine a billing destination associated with a cost relating to the usage information based on the identification information having the usage information associated therewith, stored in the first storage part;
a generation part configured to generate billing information associated with the cost to the billing destination; and
an output part configured to output the billing information.

7. A cost management method executed by a cost management system including one or more computers, the method comprising:
obtaining usage information of a device;
storing identification information having the usage information associated therewith;
determining a billing destination associated with a cost relating to the usage information based on the identification information having the usage information associated therewith;
generating the billing information associated with the cost to the billing destination; and
outputting the billing information.

8. A non-transitory computer-readable recording medium having a program stored therein for causing the cost management system to execute the cost management method as claimed in claim 7.
